(19) United States
(12) Patent Application Publication
(10) Pub. No.: US 2009/0058749 A1
(43) Pub. Date: Mar. 5, 2009

(54) PRIMARY RADIATOR FOR PARABOLIC ANTENNA, LOW NOISE BLOCK DOWN-CONVERTER, AND PARABOLIC ANTENNA APPARATUS

(76) Inventors: Hiroshi Shimoi, Osaka (JP); Toshiaki Oku, Osaka (JP)

Correspondence Address: BIRCH STEWART KOLASCH & BIRCH, PO BOX 747, FALLS CHURCH, VA, 22040-0747, US

(21) Appl. No.: 12/195,611

(22) Filed: Aug. 21, 2008

(30) Foreign Application Priority Data
Aug. 31, 2007 (JP) 2007-226204(P)

(51) Int. Cl. H01Q 13/02

(52) U.S. Cl. 343/786

(57) ABSTRACT

A primary radiator for a parabolic antenna includes a cylindrical horn antenna body widened towards an end opening in a cone shape, a horn cap provided at the end opening of the horn antenna body, and a plurality of cylindrical protruding portions formed of a dielectric. The protruding portions are provided on the inner wall surface of the horn cap, concentric with a central axis of the horn antenna body, and concentrically arranged with each other, and the height of an inner one is determined to be higher than an outer one. According to such a configuration, a primary radiator for a parabolic antenna configured to favorably suppress the VSWR up to a bandwidth of 1050 MHz can be provided.

This nonprovisional application is based on Japanese Patent Application No. 2007-226204 filed on Aug. 31, 2007, with the Japan Patent Office, the entire contents of which are hereby incorporated by reference.

### BACKGROUND OF THE INVENTION

1. Field of the Invention

The present invention relates to a primary radiator for a parabolic antenna, a low noise block down-converter (hereinafter referred to as an “LNB”) and a parabolic antenna apparatus for a satellite broadcast using the radiator and the LNB, in particular to a structure of the primary radiator for improving the VSWR (voltage standing wave ratio).

2. Description of the Background Art

A schematic diagram of a common parabolic antenna is shown in FIG. 9, and a cross sectional view of a conventional primary radiator for a parabolic antenna is shown in FIG. 10. When a satellite broadcast is received by a parabolic antenna, signals S of about 12 GHz band reflected by an antenna unit 1 are collected at an opening of a primary radiator 110, as shown in FIG. 9. The signal which has passed through primary radiator 110 is then frequency-converted by an LNB 2 from a 12 GHz band to a 1 GHz band, and this frequency-converted signal is input into an indoor receiver (BS or CS) tuner or a TV (or VTR) 4 with a built-in tuner through a cable 3.

As shown in FIG. 10, a horn antenna body 111 of a primary radiator 110 is cylindrically formed, and a horn cap 112 is fitted onto an end opening 111a, which is widened in a cone shape, by a press fit. This horn cap is intended to prevent moisture, such as rain and the like, from entering into the inside of horn antenna body 111 of the primary radiator from outside. Therefore, an O-ring 113 for water cutoff is interposed between end opening 111a of horn antenna body 111 and horn cap 112 to maintain a waterproof function.

Since this horn cap 112 is formed of resin, such as plastic and the like, it has a relatively high dielectric constant to air. Therefore, the shape of horn cap 112 will influence an input VSWR in the primary radiator to a great extent.

For example, when the BS satellite broadcast (transmission frequency of 11.7-12.0 GHz, bandwidth of 300 MHz) is received in Japan, the VSWR is influenced by horn cap 112. Therefore, a cylindrical protruding portion 114 is formed on an inner wall surface of this horn cap for suppressing the VSWR. This protruding portion is arranged concentrically with a central axis L1 of horn antenna body 111. Thus making the inside of the protruding portion hollow allows the input VSWR to be suppressed.

Moreover, in Japanese Patent Laying-Open No. 2003-324309, a horn cap is provided at an end opening of a horn antenna body, and a cylindrical protruding portion formed of a dielectric, which is arranged concentrically with a central axis of the horn antenna body, is formed on an inner wall surface of this horn cap. Additionally, an annular step which is lower inside, i.e., lower at a side closer to the center, is provided at an end of this protruding portion.

### SUMMARY OF THE INVENTION

In Japan, a satellite for a CS digital broadcast (transmission frequency of 12.2-12.75 GHz, bandwidth of 1050 MHz) has been launched at the same location with the broadcasting satellite (BS), that is, at longitude 110° east, and its service has started. Therefore, in order to receive both BS and digital CS broadcasts by one parabolic antenna, a primary radiator in which the input VSWR is low at the input frequency of 11.7 GHz-12.75 GHz (bandwidth of 1050 MHz) is needed.

However, above-described conventional primary radiator 110 for a parabolic antenna has a problem that it can hardly suppress the VSWR at the frequency with a bandwidth of up to 1050 MHz though it can suppress the VSWR at the frequency with a bandwidth of about 500-800 MHz. In addition, in a case where a good property with the suppressed VSWR is not achieved, there is another problem that it is difficult to achieve the cross polarization characteristics of not less than 23 dB for the overall antenna.

The present invention was made to solve the above problems, and an object of the present invention is to provide a primary radiator for a parabolic antenna with a structure which can favorably suppress the VSWR up to a bandwidth of 1050 MHz.

In order to achieve the above object, the primary radiator for a parabolic antenna according to the present invention includes, in one aspect, a cylindrical horn antenna body widened towards an end opening in a cone shape, a horn cap provided at the end opening of the horn antenna body, and a protruding portion having a plurality of concentric cylindrical portions formed of a dielectric and provided on an inner wall surface of the horn cap. The protruding portion projects towards the inside of the horn antenna body and is arranged concentrically with a central axis of the horn antenna body, and a height of an inner cylindrical portion, i.e., a cylindrical portion closer to the central axis, from the inner wall surface of the horn cap is determined to be higher than an outer cylindrical portion, i.e., a cylindrical portion farther from the central axis.

With such a configuration, according to the present invention, an outer and lower cylindrical portion can suppress the VSW at a high frequency, such that the input VSWR is effectively suppressed over a wide range of bandwidths of 300 MHz-1050 MHz. Moreover, the cross polarization characteristics of a subsequent block connected to the primary radiator is not deteriorated such that the good cross polarization characteristics of not less than 23 dB can be implemented.

The present invention includes the following structures in various embodiments: a structure in which an annular step which is lower outside is provided at an open end of at least one of the plurality of cylindrical portions of the protruding portion; a structure in which the height of the outer one of the cylindrical portions of the protruding portion from the inner wall surface of the horn cap is determined to be half the height of the inner one of said cylindrical portions; and a structure in which a tapered portion is provided at an open end of at least one of the plurality of cylindrical portions of the protruding portion.

The primary radiator for a parabolic antenna according to the present invention includes, in another aspect, a cylindrical horn antenna body widened towards an end opening in a cone shape, a horn cap provided at the end opening of the horn antenna body, and a cylindrical protruding portion formed of a dielectric and provided on an inner wall surface of the horn cap. The protruding portion projects towards the inside of the horn antenna body, arranged concentrically with a central axis of the horn antenna body, and an annular step, whose height from the inner wall surface of the horn cap is lower outside, is provided at an open end of the protruding portion.

According to such a configuration, an inner and higher part of the step portion of the protruding portion can suppress the VSWR at a low frequency, and an outer and lower part of the step portion of the protruding portion can suppress the VSWVR at a high frequency, such that the input VSVA is effectively suppressed over a wide range of bandwidths of 300 MHz-1050 MHz.

According to the embodiments of the present invention, an end plate of the horn cap is not limited to be flat but can be of an outwardly curved convex or concave shape.

A low noise block down-converter with the above primary radiator for a parabolic antenna and a parabolic antenna apparatus with the low noise block down-converter are also included in the present invention.

According to the primary radiator for a parabolic antenna of the present invention, by forming the height of the inner cylindrical portion higher than the height of the outer cylindrical portion, the inner and higher cylindrical portion can suppress the VSWR at a low frequency and the outer and lower cylindrical portion can suppress the VSWR at a high frequency, such that the input VSWR is effectively suppressed over a wide range of bandwidths of 300 MHz-1050 MHz. Moreover, the cross polarization characteristics of a subsequent block connected to the primary radiator is not deteriorated such that the good cross polarization characteristics of not less than 23 dB can be implemented.

Moreover, by circumferentially forming the annular step portion which is lower outside in the vicinity of the end opening of the protruding portion, the VSWR can be suppressed at a high frequency such that the input VSWR is effectively suppressed over a wide range of bandwidths of 300 MHz-1050 MHz. Moreover, the cross polarization characteristics of a subsequent block connected to the primary radiator is not deteriorated such that the good cross polarization characteristics of not less than 23 dB can be implemented.

Furthermore, according to the present invention, since the diameter of the horn cap can be made smaller than the diameter of a cap of the conventional corrugated feed horn, the primary radiator can be downsized. Moreover, the present invention is also advantageous in that a radiation angle at the primary radiator can be made larger.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1-5 are cross sectional views of a primary radiator for a parabolic antenna according to first to fifth embodiments of the present invention, respectively.

FIG. 6 shows a difference between diameters of a corrugated feed horn and a conical feed horn.

FIGS. 7A, 7B and 7C are diagrams showing radiation patterns for the conventional conical feed horn, and FIG. 7A shows a case where the frequency of a signal is 10.7 GHz, FIG. 7B shows a case where the frequency of the signal is 11.7 GHz, and FIG. 7C shows a case where the frequency of the signal is 12.75 GHz, respectively.

FIGS. 8A, 8B and 8C are diagrams showing radiation patterns for the conical feed horn having a protruding portion according to the present invention, and FIG. 8A shows a case where the frequency of the signal is 10.7 GHz, FIG. 8A shows a case where the frequency of the signal is 11.7 GHz, and FIG. 8B shows a case where the frequency of the signal is 12.75 GHz, respectively.

FIG. 9 is a schematic side view of a common parabolic antenna.

FIG. 10 is a cross sectional view of a conventional primary radiator for a parabolic antenna.

### DESCRIPTION OF THE PREFERRED EMBODIMENTS

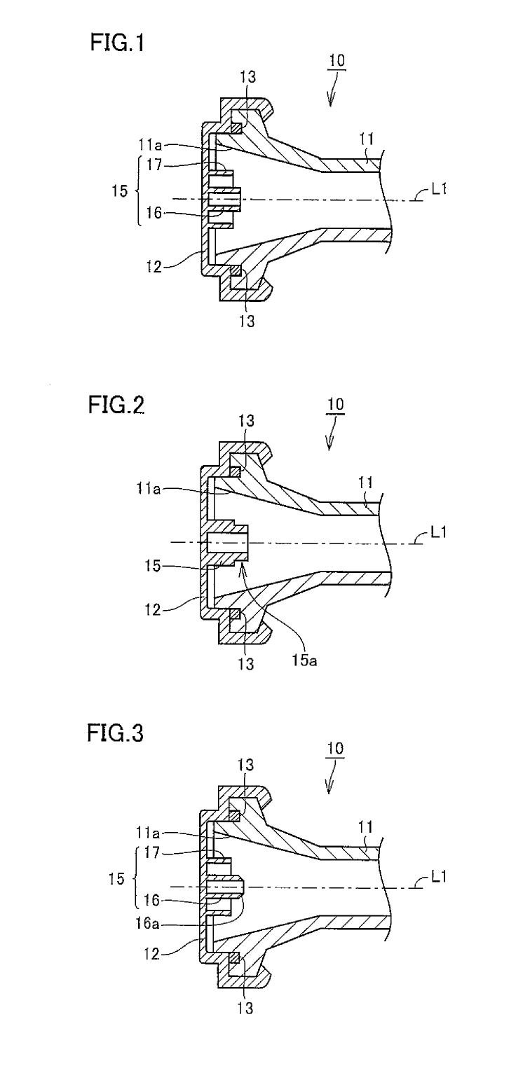

A first embodiment of the present invention will be described below based on FIG. 1. In FIG. 1, a primary radiator 10 for a parabolic antenna of the first embodiment is configured as follows. A horn antenna body 11 is cylindrically formed and a horn cap 12 is fitted onto an end opening 11a, which is widened in a cone shape, by a press fit. An O-ring 13 for water cutoff is interposed between end opening 11a of horn antenna body 11 and horn cap 12.

A protruding portion 15 including two cylindrical portions 16 and 17 formed of a dielectric is provided on an inner wall surface of horn cap 12, projecting towards the inside of horn antenna body 11, and arranged concentrically with a central axis of horn antenna body 11. In addition, the height of inner cylindrical portion 16 from the inner wall surface of horn cap 12 is formed to be higher than outer cylindrical portion 17.

According to such a configuration, the outer and lower cylindrical portion 17 can suppress the VSWR at a high frequency and the inner and higher cylindrical portion 16 can suppress the VSWR at a low frequency, such that the input VSWR is effectively suppressed over a wide range of bandwidths of 300 MHz-1050 MHz. Moreover, the cross polarization characteristics of a subsequent block connected to the primary radiator is not deteriorated such that the good cross polarization characteristics of not less than 23 dB can be implemented. The VSVWR can be suppressed more effectively by determining the relationship between the heights of two cylindrical portions 16 and 17 from the inner wall surface of horn cap 12 such that outer cylindrical portion 17 is half (½) as high as inner cylindrical portion 16.

Although a case where two cylindrical portions are concentrically provided as one protruding portion is shown in the above first embodiment, the same effect can be achieved by concentrically providing three or more cylindrical portions and setting the height of an inner cylindrical portion higher than the height of an outer cylindrical portion.

A second embodiment of the present invention will now be described based on FIG. 2. Cylindrical protruding portion 15 formed of a dielectric is provided on the inner wall surface of horn cap 12 of the second embodiment, and arranged concentrically with the central axis of horn antenna body 11. In addition, an annular step portion 15a is circumferentially formed in the vicinity of an open end of protruding portion 15.

Owing to this step portion 15a, the VSWR at a high frequency can be suppressed such that the input VSWR is effectively suppressed over a wide range of bandwidths of 300 MHz-1050 MHz. Moreover, the cross polarization characteristics of a subsequent block connected to the primary radiator is not deteriorated such that the good cross polarization characteristics of not less than 23 dB can be implemented. The VSWR can also be effectively suppressed by concentrically providing, as shown in the first embodiment, a plurality of cylindrical portions having the step according to the present embodiment.

A cross sectional structure of a primary radiator according to a third embodiment of the present invention is shown in FIG. 3. In the third embodiment, a plurality of cylindrical portions 16 and 17 are provided as protruding portion 15, and a tapered portion 16a is formed at an open end of inner cylindrical portion 16. Owing to this tapered portion 16a, the VSWR can be suppressed.

Although an example in which a tapered portion is formed at the open end of only inner cylindrical portion 16 is shown in the third embodiment, a tapered portion may be formed at open ends of both inner and outer cylindrical portions, as shown in a cross sectional view on the right-hand side of FIG. 6. According to the structure shown on the right-hand side of FIG. 6, the diameter of horn cap 12 can be as small as 45 mm, with respect to the diameter of 60 mm of a feed horn cap 212 of a conventional corrugated feed horn 200 shown on the left-hand side of the same drawing, thereby allowing downsizing of the primary radiator.

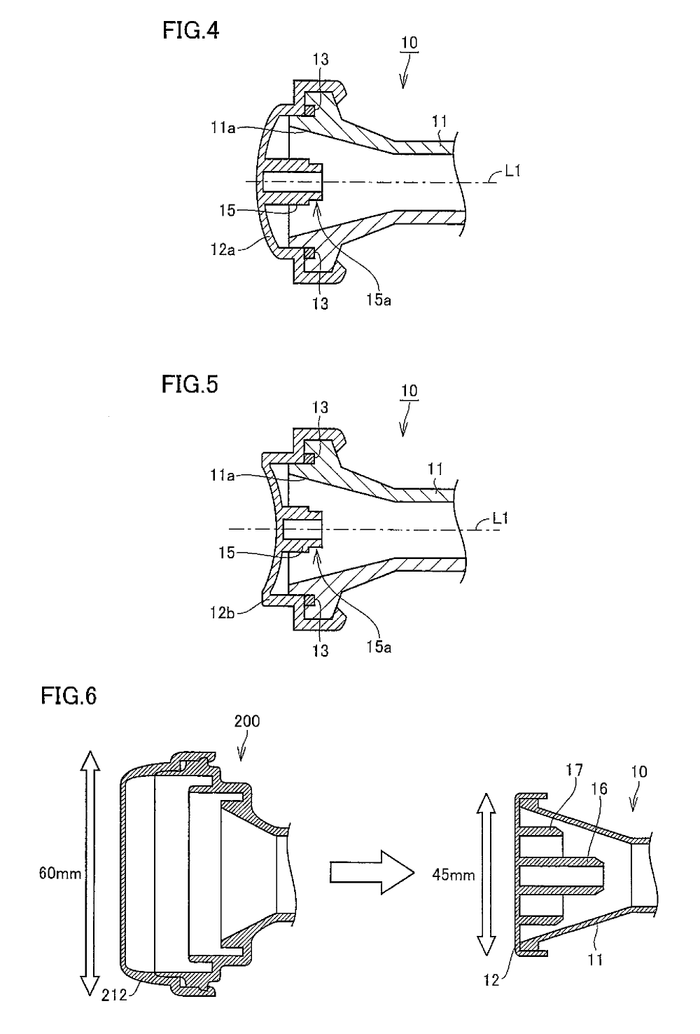

A cross sectional structure of a primary radiator according to a fourth embodiment of the present invention is shown in FIG. 4. In the fourth embodiment, an end plate 12a of horn cap 12 is of an outwardly curved convex shape, thereby suppressing the VSWR. Moreover, a cross sectional structure of a primary radiator according to a fifth embodiment of the present invention is shown in FIG. 5. In the fifth embodiment, an end plate 12b of horn cap 12 is of an outwardly curved concave shape, thereby suppressing the VSWR.

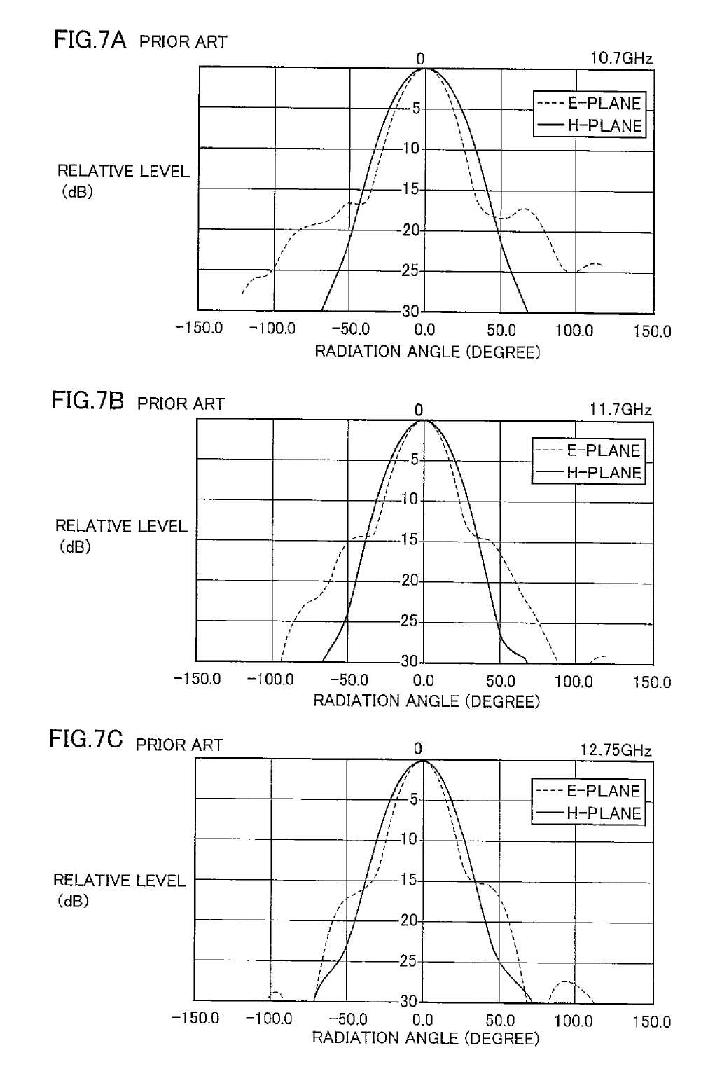

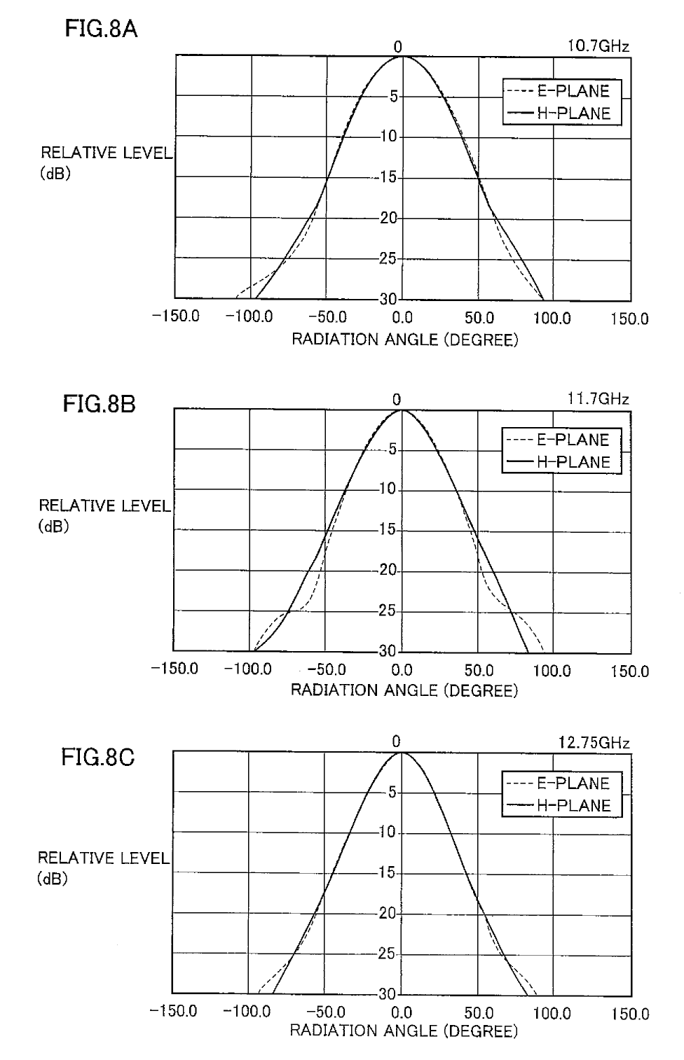

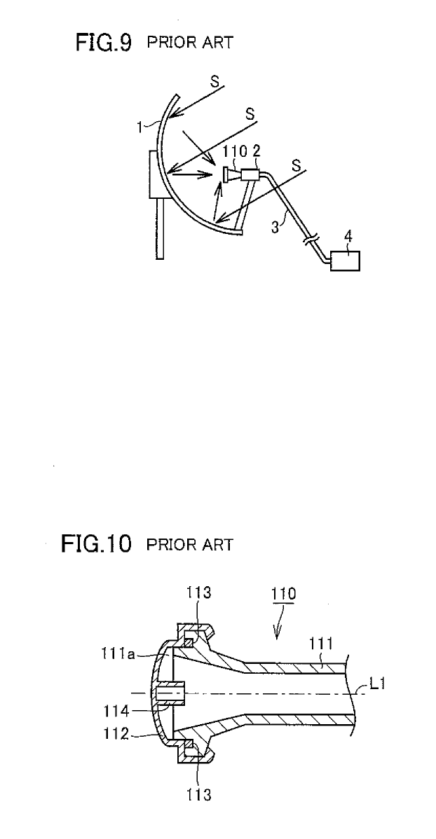

The radiation patterns for the conventional conical feed horn, shown in FIG. 10, are shown in FIGS. 7A, 7B and 7C, and the radiation patterns for the conical feed horn according to the fourth embodiment of the present invention, shown in FIG. 4, are shown in FIGS. 8A, 8B and 8C, respectively. FIGS. 7A and 8A show a case where the frequency of a signal is 10.7 GHz, FIGS. 7B and 8B show a case where the frequency of the signal is 11.7 GHz, FIGS. 7C and 8C show a case where the frequency of the signal is 12.75 GHz, respectively. In these diagrams of radiation patterns, the horizontal axis expresses the radiation angle, and the vertical axis expresses the relative level (dB). Note that the pattern referred to as an “E-plane” through FIGS. 7A-8C shows a radiation pattern which is parallel to an electric field generated inside the feed horn (inside the circular waveguide), and the pattern referred to as an “H-plane” shows a radiation pattern which is vertical to the electric field.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A primary radiator for a parabolic antenna comprising:
a cylindrical horn antenna body widened towards an end opening in a cone shape;
a horn cap provided at said end opening of said horn antenna body; and
a protruding portion having a plurality of concentric cylindrical portions formed of a dielectric and provided on an inner wall surface of said horn cap,
said protruding portion projecting towards the inside of said horn antenna body, being arranged concentrically with a central axis of said horn antenna body, and a height of an inner one of said cylindrical portions from the inner wall surface of said horn cap being determined to be higher than an outer one of said cylindrical portions.

2. The primary radiator for a parabolic antenna according to claim 1, wherein
an annular step which is lower outside is provided at an open end of at least one of said plurality of cylindrical portions of said protruding portion.

3. The primary radiator for a parabolic antenna according to claim 1, wherein
the height of the outer one of said cylindrical portions of said protruding portion from the inner wall surface of said horn cap is determined to be half the height of the inner one of said cylindrical portions.

4. The primary radiator for a parabolic antenna according to claim 1, wherein
a tapered portion is provided at an open end of at least one of said plurality of cylindrical portions of said protruding portion.

5. The primary radiator for a parabolic antenna according to claim 1, wherein
an end plate of said horn cap is of an outwardly curved convex or concave shape.

6. A low noise block down-converter comprising the primary radiator for a parabolic antenna according to claim 1.

7. The low noise block down-converter according to claim 6, comprising, for receiving a satellite broadcast, a plurality of sets of said primary radiator for a parabolic antenna.

8. A parabolic antenna apparatus comprising the low noise block down-converter according to claim 6.

9. A primary radiator for a parabolic antenna comprising:
a cylindrical horn antenna body widened towards an end opening in a cone shape;
a horn cap provided at said end opening of said horn antenna body; and
a cylindrical protruding portion formed of a dielectric and provided on an inner wall surface of said horn cap,
said protruding portion projecting towards the inside of said horn antenna body, being arranged concentrically with a central axis of said horn antenna body, and including an annular step, whose height from the inner wall surface of said horn cap is lower outside, at an open end of said protruding portion.

10. The primary radiator for a parabolic antenna according to claim 9, wherein
an end plate of said horn cap is of an outwardly curved convex or concave shape.

11. A low noise block down-converter comprising the primary radiator for a parabolic antenna according to claim 9.

12. The low noise block down-converter according to claim 11 comprising, for receiving a satellite broadcast, a plurality of sets of said primary radiator for a parabolic antenna.

13. A parabolic antenna apparatus comprising the low noise block down-converter according to claim 11.
